(19) United States
(12) Patent Application Publication
(10) Pub. No.: US 2018/0357381 A1
(43) Pub. Date: Dec. 13, 2018

(54) Method and System for Generating Persistent Local Instances of Ontological Mappings

(71) Applicant: Intelligent Medical Objects, Inc., Northbrook, IL (US)

(72) Inventors: Gregory R. Aldin, Oak Park, IL (US); Laura DeBuys, Evanston, IL (US); Sebastian Frith, Champaign, IL (US); Jim Mudra, Cary, IL (US); Ivana Naeymi-Rad, Libertyville, IL (US); Leslie Brody, Skokie, IL (US)

(73) Assignee: Intelligent Medical Objects, Inc.

(21) Appl. No.: 15/618,352

(22) Filed: Jun. 9, 2017

(51) Int. Cl. G06F 19/00; G06F 17/27

(52) U.S. Cl. CPC G06F 19/322; G06F 17/2785; G06F 3/0482; G06F 19/326; G06F 17/2705

(57) ABSTRACT

A system and method for generating local deployments of ontological mappings includes comparing a customizable version of an ontological mapping with a reference version and determining differences in the mappings. The differences may be used to generate a local instantiation to record the user's preferences, the local instantiation being retained on the user's computer system or accessible only by the user or a system administrator, i.e., not accessible by an unrelated user. The local instantiation then exhibits permanence, remaining accessible by the user to manually or automatically update the most recent ontological mapping to incorporate the user's mappings.

### BACKGROUND

### 1. Field of the Invention

The present application is directed to systems and methods for managing local deployments of ontological mappings, such as mappings between an interface terminology and one or more external codes sets. In one aspect, the interface terminology and external code sets may be used to encode data in one or more domains for recordkeeping within a plurality of electronic health records or other data repositories.

### 2. Description of the Related Art

Electronic medical ontologies, also known as medical classification codes, are necessary with the implementation and proliferation of electronic medical records. Various ontologies have been developed for various reasons, including administrative code sets that may be designed to support administrative functions of healthcare, such as reimbursement and other secondary data aggregation; clinical code sets that encode specific clinical entities involved in clinical work flow and allow for meaningful electronic exchange and aggregation of clinical data for better patient care; and reference terminology code sets that may be considered a “concept-based, controlled medical terminology” to maintain a common reference point in the healthcare industry. Reference terminologies also identify relationships between their concepts, e.g., relationships can be hierarchically defined, such as a parent/child relationship. Common examples of administrative code sets are the International Classification of Diseases (ICD) and the Current Procedural Terminology, which is referred to via the trademark CPT. Examples of clinical code sets are the Logical Observation Identifiers Names and Codes, referred to under the trademark LOINC, and a normalized terminology for medication information, such as the terminology of the National Library of Medicine referred to under the trademark RxNorm. One example of a reference terminology is the Systematized Nomenclature of Medicine—Clinical Terms, referred to under the trademark “SNOMED CT.”

One challenge with implementing an electronic medical ontology is to ensure the accuracy and completeness of recordkeeping, at the time of the patient visit or otherwise during data entry. One method of structuring and codifying the data to achieve this goal includes implementing an interface terminology that recognizes semantic meaning, mapping that interface terminology to the various other ontologies, and then relying on that interface terminology to analyze the practitioner's entries. One example of a system and method for using an interface terminology and the relevant ontology mappings may be found in the commonly-owned U.S. Pat. No. 9,594,872, issued Mar. 14, 2017, the contents of which are incorporated by reference in their entirety. In that example, the interface terminology comprises a plurality of concepts within one or more domains (problem, procedure, plan, medication, etc.) and one or more descriptions (lexicals) linked to each concept, where each description reflects clinical intent and an alternative way to express the concept.

The process of mapping between an ontology such as an interface terminology and one or more external code sets, such as an administrative terminology, a clinical terminology, and/or a reference terminology, is dynamic, with mappings being added or deleted as the elements of the ontology or of the code sets are added, removed, or otherwise modified. For example, since descriptions or lexicals within the interface terminology may reflect clinical intent, variants of those descriptions may be developed over time as a practitioner or institution develops a personalized way of expressing the underlying concept. Alternatively, as the various terminologies are modified or updated, such as with the transition from ICD-9 to ICD-10, numerous terminology elements may be added, eliminated, or otherwise modified, and maps to those elements must be created or modified accordingly.

One benefit of mappings between interface terminology elements and the various external code set elements is that a user can rely on their clinical intent to represent a problem, procedure, etc., with the mapping then determining the appropriate external code element, thereby freeing the clinician from having to recall or search for each specific external code element. At the same time, however, it may be difficult for physicians, billing agents, or other terminology users to keep track of the modifications in mappings to ensure that their clinical intent is being mapped to the most accurate, most complete, or otherwise most appropriate external code elements. Similarly, if a clinician's term is mapped to a deactivated external code element, the clinician's documentation may not map to external codes that are necessary for adequate documentation, billing, etc., which may require a billing agent or other individual to have to seek out the clinician at a later date to discern what an appropriate mapping should be, which may result in inaccuracies and/or the expense of additional time and resources. These difficulties may be exacerbated by the fact that the specific changes from release to release may not be published to end users. As such, the first time those users may ascertain whether relevant changes have been made may be when they attempt to use a deactivated, deleted, or otherwise outdated mapping.

In contrast to the benefits provided by broad adoption of an interface terminology, e.g., more uniform documentation and more accurate and timely billing, widespread use of the interface terminology may be met with a lack of user customization. For example, if an end user disagrees with a mapping between an interface terminology and an ICD-10 code, it may take the agreement of a significant number of other end users in order to effectuate a change in the mapping. Until then, or if such agreement is not reached, the end user may not have the benefit of a mapping that more specifically addresses one or more situations it documents.

What are needed are a system and method that preferably address one or more of these challenges.

### BRIEF SUMMARY

In one aspect, a method for generating local deployments of ontological mappings includes the steps of: receiving a user selection of a reference ontological mapping, wherein the reference ontological mapping is loaded on a computer system, receiving a user selection of a customizable ontological mapping, wherein the customizable ontological mapping includes an indicator for one or more individual mappings within the customizable ontological mapping, parsing the customizable ontological mapping according to the indicator for the one or more individual mappings, generating a subset of the customizable ontological mapping based on the parsing step, presenting the subset to a user, receiving user-generated modifications to the subset, and saving the user-generated modifications in a local instantiation of an ontological mapping.

In another aspect, a method for generating local deployments of ontological mappings includes the steps of: receiving a user selection of a reference ontological mapping, wherein the reference ontological mapping is loaded on a computer system, receiving a user selection of a customizable ontological mapping, wherein the customizable ontological mapping includes an indicator for one or more individual mappings within the customizable ontological mapping, parsing the customizable ontological mapping according to the indicator for the one or more individual mappings, generating a subset of the customizable ontological mapping based on the parsing step, presenting the subset to a user, receiving user-generated modifications to metadata affiliated with the subset, and saving the user-generated modifications in a local instantiation of an ontological mapping.

### BRIEF DESCRIPTION OF THE SEVERAL VIEWS OF THE DRAWINGS

FIG. 1 is a depiction of exemplary ontology mapping data stored in a table format;

FIG. 2 is a depiction of exemplary ontology mapping data stored as comma-separated values;

FIG. 3 is a screenshot of a user interface for receiving a user selection of a reference data file or files containing an ontological mapping;

FIG. 4 is a screenshot of a user interface for receiving a user selection of a customizable data file or files containing an ontological mapping;

FIG. 5 is a screenshot of a user interface for receiving a user selection to begin analyzing the customizable data file or files against the reference data file or files;

FIG. 6A is the upper half of a screenshot of a user interface for evaluating differences between the reference and the customizable mappings;

FIG. 6B is a continuation of FIG. 6A and is the lower half of a screenshot of a user interface for evaluating differences between the reference and the customizable mappings;

FIG. 7 is a screenshot of a user interface for presenting a user with candidate replacement ontological mappings;

FIG. 8 is a screenshot of a user interface for receiving a user selection of a candidate replacement ontological mapping;

FIG. 9A is the upper half of a screenshot of a user interface incorporating a search engine for identifying and selecting a replacement ontological mapping;

FIG. 9B is a continuation of FIG. 9A and is the lower half of a screenshot of a user interface incorporating a search engine for identifying and selecting a replacement ontological mapping;

FIG. 10 is a screenshot of a user interface for selecting or modifying certain metadata elements associated with an interface terminology mapping;

FIG. 11 is a screenshot of a user interface summarizing local modifications made to the customizable mapping and prompting the user to build a local instance of the modified mappings;

FIG. 12A is the upper half of a screenshot of a user interface providing visual warnings to a user when attempting to change certain interface terminology mappings; and

FIG. 12B is a continuation of FIG. 12A and is the lower half of a screenshot of a user providing visual warnings to a user when attempting to change certain interface terminology mappings.

### DETAILED DESCRIPTION

As set forth in greater detail herein, the present system and method are operable within a network of computer systems, with a plurality of computers each having a processor configured to operate electronic health record (“EHR”) software accessible by one or more care providers to document patient encounters. In one aspect, each computer system operates the same EHR software. In another aspect, the computer systems may operate different EHR software packages that receive and/or store patient data in different ways. In this latter aspect, however, the various EHR software packages may interface with a common ontology such as an interface terminology in order to provide a common encoding mechanism for their respective sets of patient data.

As described in greater detail below, the present system and method permit end users to manage local deployments of ontological mappings, such as mappings between an interface terminology and one or more external code sets and metadata elements ascribed to the interface terminology or external code set elements. As part of that process, the system and method provide for release-to-release comparison, support local terminology customizations by allowing users to customize default mappings, generate or modify local versions of the mappings within the interface terminology, permit customization of the interface terminology itself, facilitate editing of metadata associated with the mappings, the interface terminology, or one or more of the external code sets, and leverage local usage data to make informed customization decisions about mappings.

In one aspect, the system includes a plurality of data files that include data such as: 1) each interface terminology concept, 2) unique identifiers pertaining to each interface terminology concept, 3) one or more interface terminology descriptions (or lexicals), 4) mappings between the interface terminology descriptions and their relevant concepts, 5) elements of one or more external code sets, 6) unique identifiers pertaining to each of the elements of the one or more external code sets, 7) mappings between the interface terminology concepts or descriptions and the elements of the one or more external code sets, 8) metadata relating to the interface terminology concepts or descriptions, and 9) metadata relating to the external code set elements.

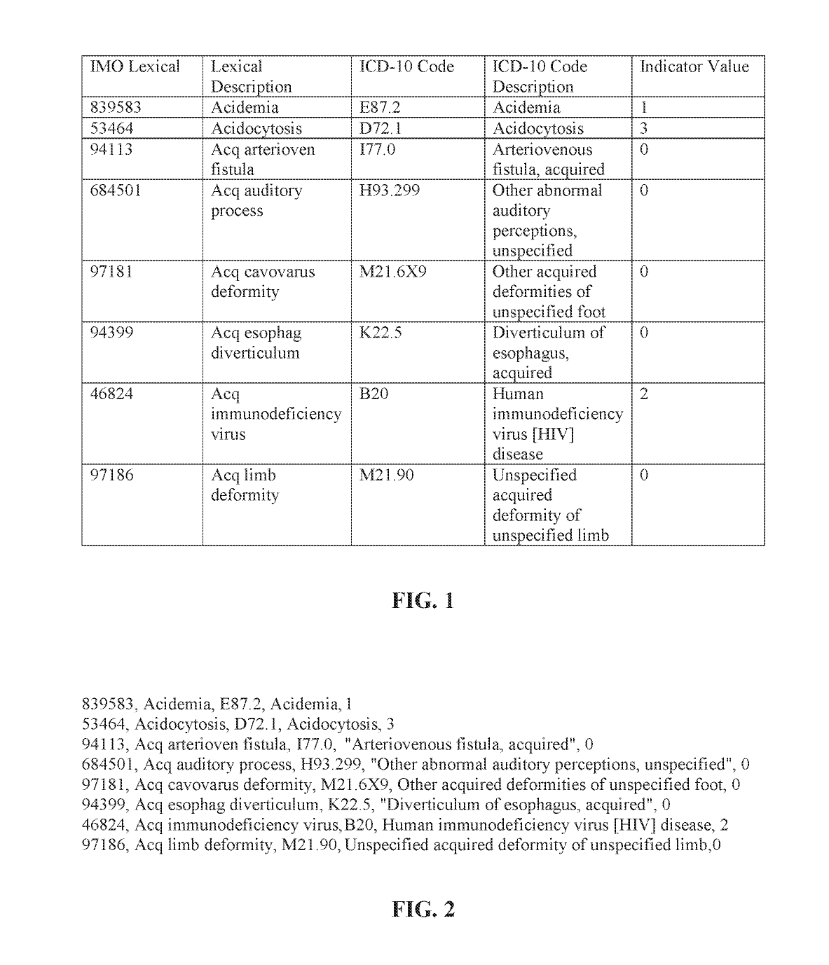

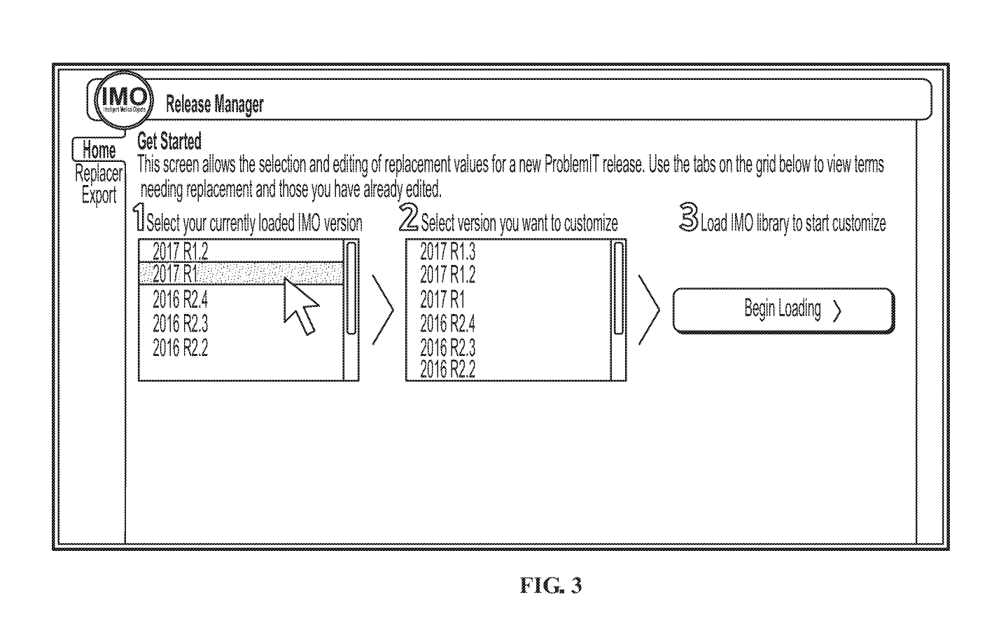

Data may be stored or arranged in multiple ways. For example, the data files may be relational or other types of databases, with tables for one or more of the categories of data listed above, and links between the tables used to account for other categories, e.g., for the mappings between categories of data. Additionally or alternatively, the data may be stored in one or more text files, e.g., in tabular form as seen in FIG. 1 or as plain text as a plurality of comma-separated values, as seen in FIG. 2. In order to appreciate the scope of the mappings, in one exemplary system, there may be between about 20 and about 30 text files totaling between about 4 and about 5 Gb of storage. Alternatively, files could be delivered by a portal service, either locally or in a centralized cloud location.

Just as data may be stored or arranged in multiple ways, so too may the customization to the ontological mapping. For example, a user may be permitted to customize the interface terminology itself, e.g., by adding, deleting, hiding, or otherwise modifying one or more local instances of interface terminology concept-description mappings. Similarly, the system may permit the addition or removal of an external code set element. Moreover, the system may permit modification of the mapping between an interface terminology element and an external code set element, as discussed in greater detail below. Still further, the system may permit modifications to the metadata associated with one or more of the external code sets and/or the interface terminology.

Updates to one or more of the data files may be pushed automatically to a user's computer systems. Alternatively, users may be advised that updates are available but must actively obtain or download the updated data files.

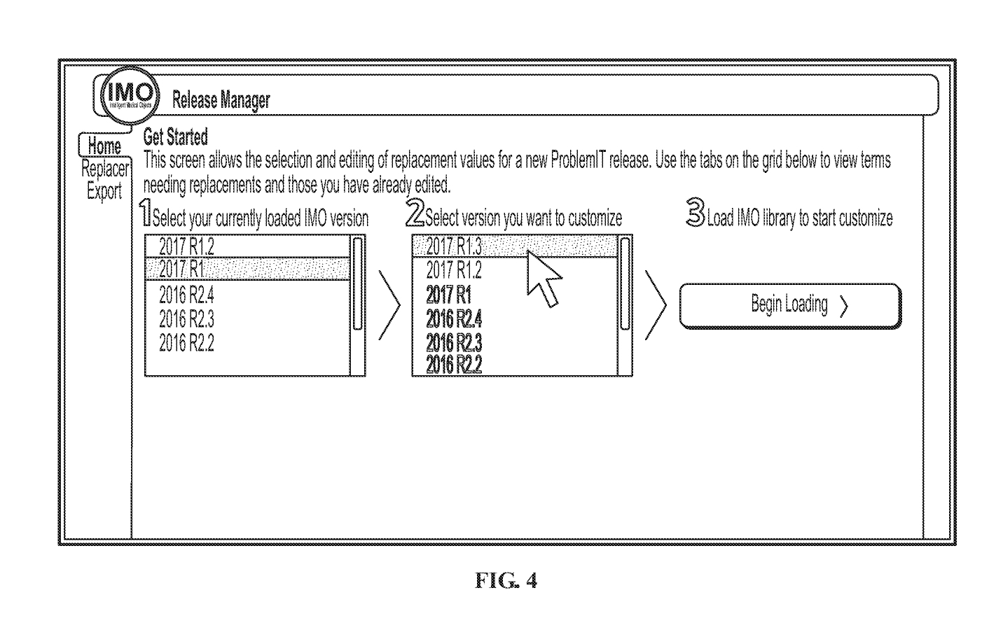

In either case, once the updated data files have been downloaded to the user's computer system, the system may permit installation of the newest version of the ontology mapping. As part of that process, and as seen in FIG. 3, the user may be prompted to select a reference mapping version. By default, that version may be the version currently loaded on the local computer system. In one aspect, the computer system may recognize what version that is and highlight it for the user's selection. Alternatively, however, the system may permit the user to select a different version to serve as the reference version, thereby permitting a user to compare any two versions of the ontology mappings.

Turning to FIG. 4, the system then may prompt the user to select the version to be customized. The system may default the customizable version to be the one most recently downloaded to the system or the most recent one available for downloading. Similar to the reference version, however, the system may permit the user to select an older version to serve as the customizable version.

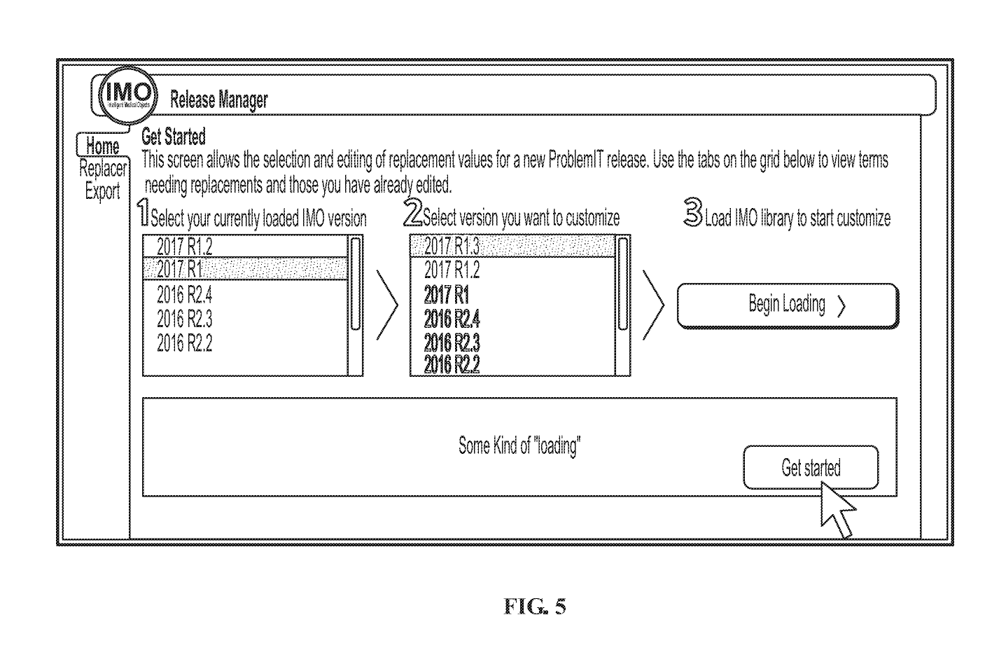

Turning to FIG. 5, the system then may receive a user command to load the customizable version and to compare the ontology mappings between the reference and customizable versions. In one aspect, the process of comparing mappings may include evaluating an indicator value assigned to each mapping, such as the indicator values depicted in FIGS. 1 and 2. In this example, an indicator of “0” may mean that the mapping has been deactivated, an indicator of “1” may signify that the mapping is active and unchanged from the previous version, an indicator of “2” may signify that the mapping is active but modified from the previous version, and an indicator of “3” may signify that the mapping is newly-added as compared to the previous version. The indicator values may be applied to the customizable version as part of the data file or files being loaded into the system. Alternatively, the system may generate one or more of the indicator values as a direct result of a comparison between the reference and customizable versions. For example, the system may compare the two versions and automatically apply the “3” indicator to mappings that are present in the customizable version but not in the reference version. Similarly, the system may automatically apply the “0” indicator to mappings that are present in the reference version but not the customizable one.

It will be understood that these indicators are merely exemplary, that more or fewer indicators may be used to describe the state of each mapping, and that other types of indicators may be used to represent mapping variants. Other indicators, e.g., “new,” “modified,” deactivated,” “reactivated,” “unchanged,” etc., or other numeric, alphabetic, alphanumeric, or symbolic indicators, may be employed to categorize each mapping. Additionally, it will be appreciated that, for at least the “active and unchanged” and “active but modified” indicators, it may be necessary to compare that indicator value against each version of the ontological mappings between the reference version and the customizable version in order to determine whether those mappings are accurate as they relate to the comparison with the reference version.

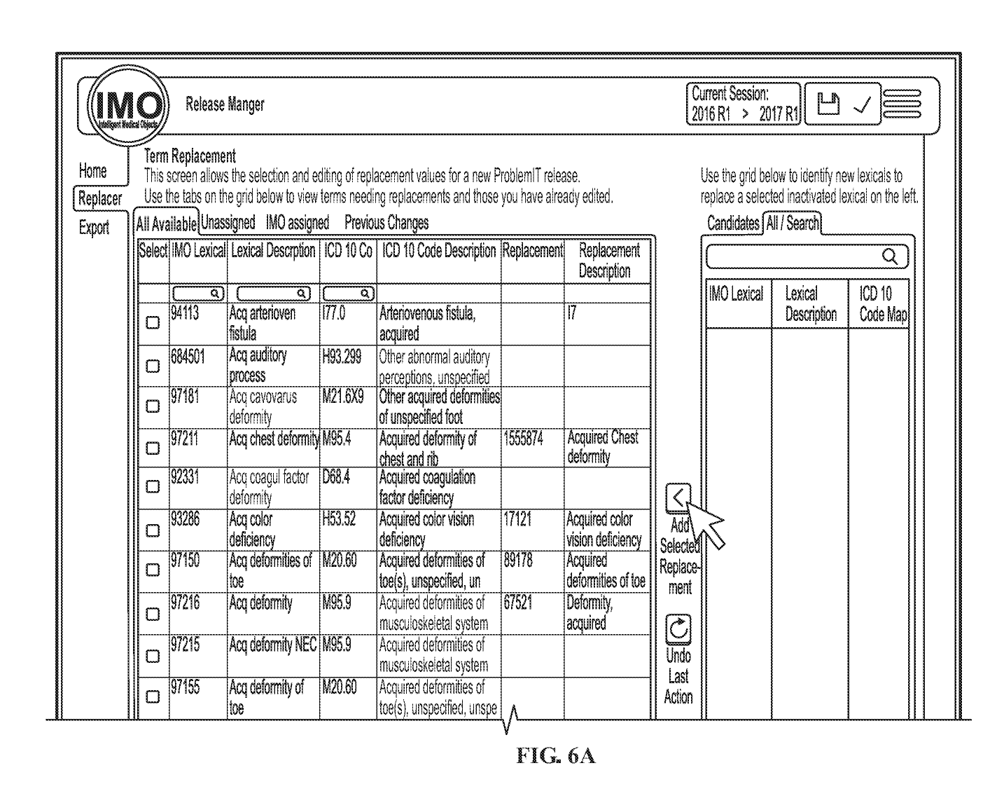

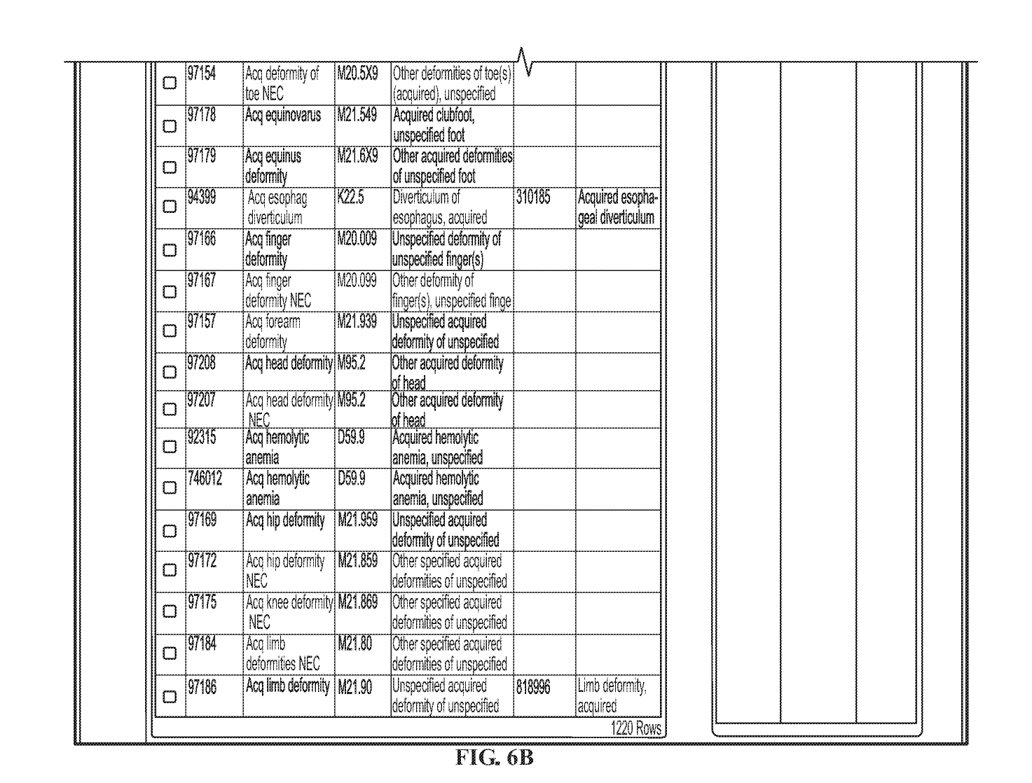

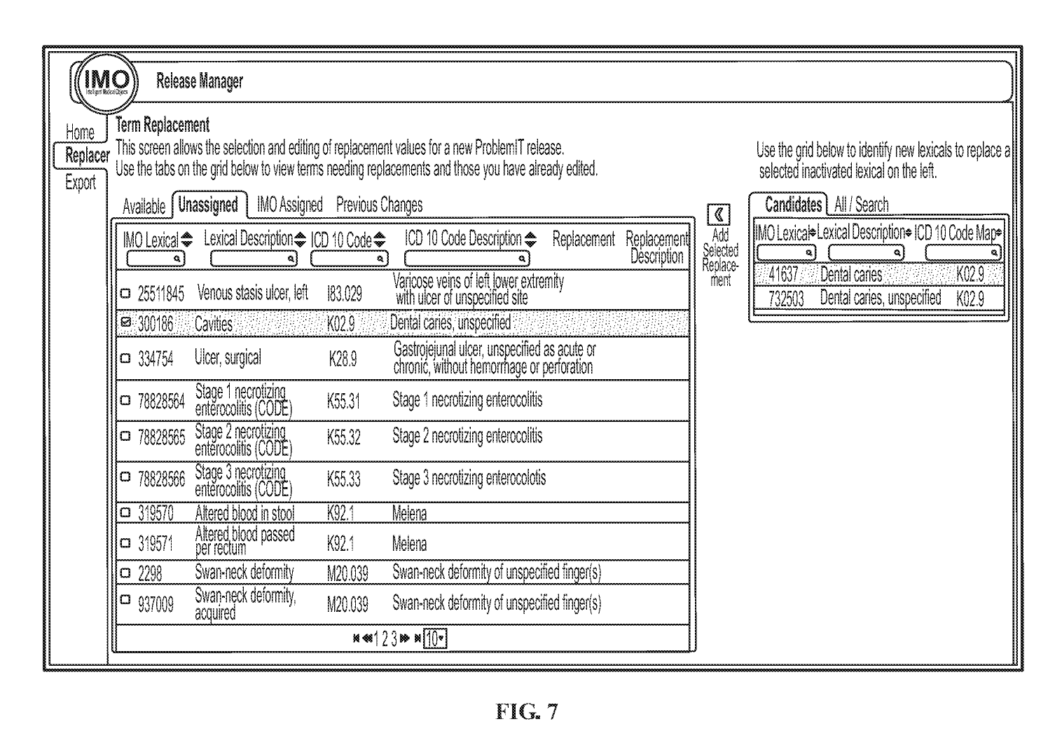

Once the customizable version has been loaded and compared with the reference version, the system may present the user with a list or table of all entries (or a subset of entries) within an ontology or within one or more domains within that ontology, which may be, e.g., a list of problems, procedures, medications, labs, etc. In another aspect, as seen in FIGS. 6A and 6B, the list or table presented to the user may not include all mappings to entries within an ontology, as there may be thousands of entries in the ontology. Instead, the list or table presented to the user may be a more limited subset, such as the ontology terms that were deactivated from the previously-installed release to the one having just been loaded. Other alternatives include, e.g., presenting the user with newly-generated ontology mappings and/or mappings that were modified as between the reference and customizable versions.

As seen in FIGS. 6A and 6B, each entry in the list or table includes an ontology description element and an identifier for that description, as well as a mapping to an external code set (e.g., an ICD-10 or SNOMED code), which may include both a description and an identifier for that code set element. One or more mapped descriptions may be a subject of possible replacement. In particular, a replacement may be a way to replace a newly-inactivated interface terminology term, where the system may present the user with a possible replacement, where there may not be sufficient consensus, or where there may be a local convention different from general consensus that dictates not presenting the user with a suggested replacement. When suggested replacements are made available, the table may include a system-proposed replacement description and related replacement identifier, where the replacement description and identifier are other entries in the ontology.

In one aspect, the system may only present the user with a proposed replacement when that replacement reflects an exact equivalence with the external code set description. In this context, equivalence may refer to semantic or clinical equivalence, as opposed to identity of terminology. For example, “fracture of left arm” may be deemed an exact equivalent to “fracture of left upper extremity” and/or “fx left arm.” Similarly, as seen in FIGS. 6A and 6B, “Acquired chest deformity” may be deemed an exact equivalent to “Acquired deformity of chest and rib.”

The system may distinguish these suggestions from other entries in the table for which the user has selected a replacement or affirmatively confirmed the system's suggestion. For example, the suggested entries may be highlighted a different color as compared to other replacement entries. Alternatively, the suggested entries may be highlighted while the other replacement entries are not, in order to indicate to the user that additional action may be necessary with regard to those suggested entries.

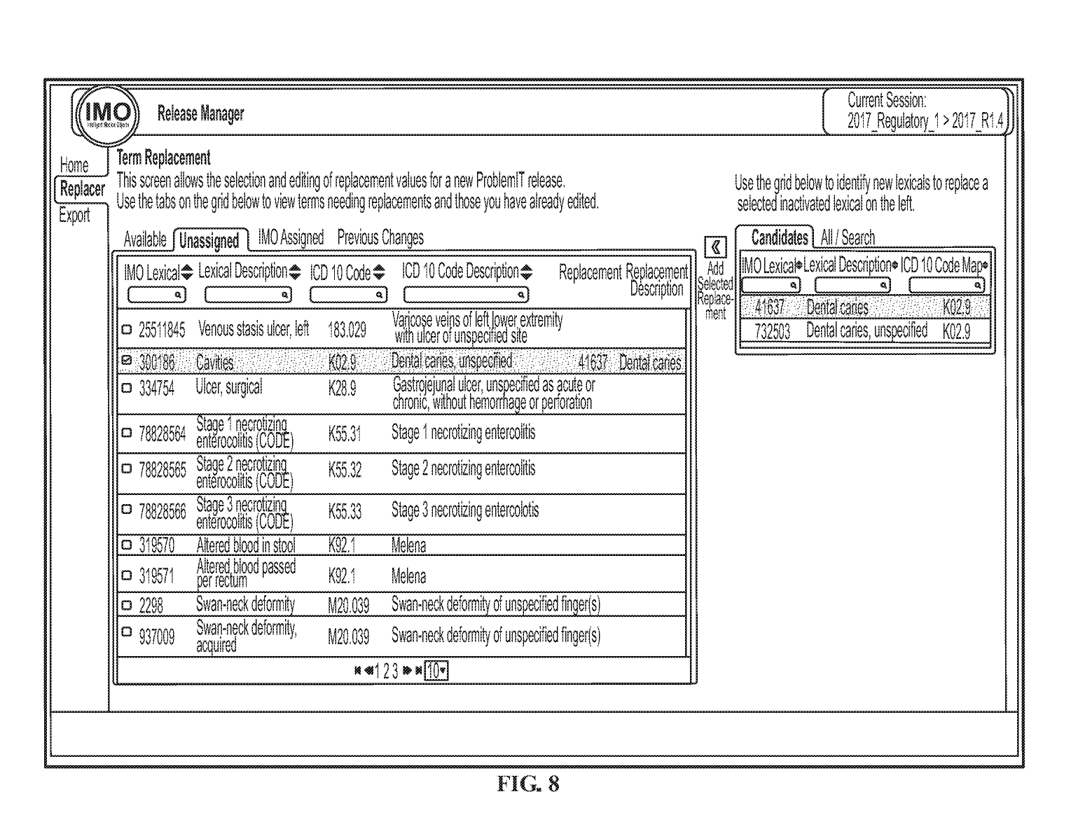

In another aspect, as seen in FIGS. 7 and 8, other replacements may be available but not presented to the user because they may not meet the exact equivalence criterion. For example, a potential replacement term may be broader or narrower than the term being replaced, or the replacement term may not include laterality associated with the code set description. In those situations, and even in the situations in which the system presents the user with a suggested replacement, the system may provide the user with a list of one or more candidate matches. Such matches may lack the exact equivalence necessary to be automatically populated in the replacement list or table but at the same time may include objective or subjective matches or similarity indicators to the highlighted external code set description that justify categorizing those elements as potential candidates for replacement. For example, a candidate match may include a mapping to an external code set description that, in turn, maps to an identical external code set identifier. This is possible, because multiple elements of an interface terminology may map to the same external code set description, as such mappings may represent the best possible outcome given the granularity of the external code set. For example, FIG. 7 illustrates that the interface terminology descriptions for “Swan-neck deformity” and “Swan-neck deformity, acquired” both may map to the ICD-10 description “Swan-neck deformity of unspecified finger(s)” and its corresponding ICD-10 code M20.039. Alternatively, a term may be considered a candidate match based on a subjective determination that it semantically is similar to the term being replaced. In yet another example, a term may qualify as a candidate match based on a hierarchical or other organizational similarity to another term in the external code set, directly or indirectly via additional mappings to the interface terminology. For example, interface terminology elements corresponding to an external code set being retired also may map to a hierarchically organized code set such as SNOMED, and the candidate matches may be terms that map to SNOMED terms that are, e.g., one term more or less specific on that SNOMED hierarchy. Still other methods for determining candidate matches may be available.

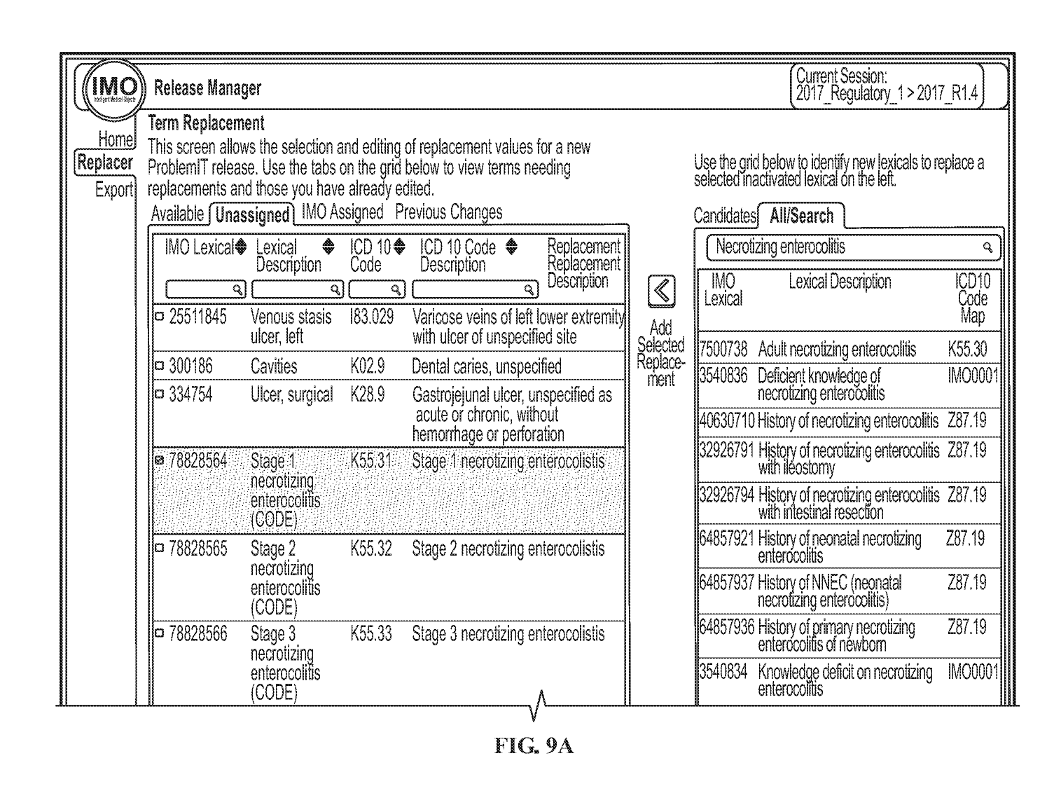

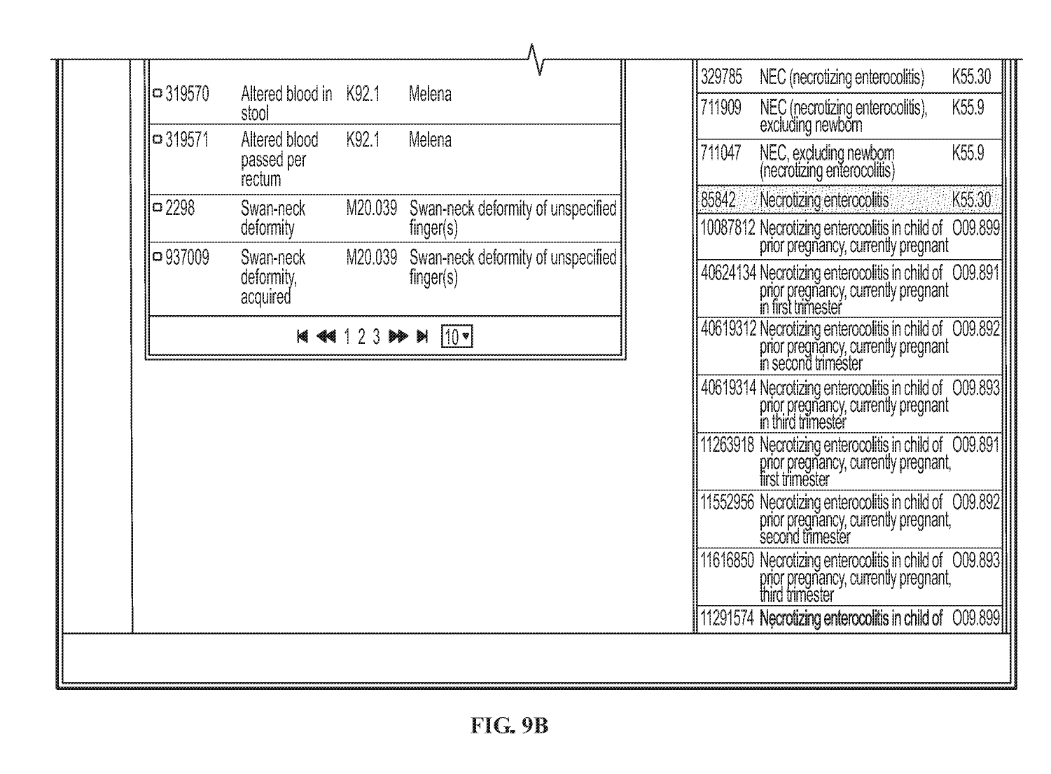

Turning now to FIGS. 9A and 9B, the system further may include a search functionality for receiving user input terms, such that terms may be searchable even if the system provides the user with exact equivalence matches or with candidate matches. Upon receiving those user inputs, the system then may search its database or other record of ontological descriptions with the goal of returning one or more potential matches to the user. Search analysis techniques may include searching the ontological descriptions for exact matches, synonyms, misspellings matching the search query, selections made by other users for the same or similar search term, and/or other techniques as would be appreciated by one of ordinary skill in the relevant art.

The system then may receive a user selection of one of search results to create a localized mapping of that ontological description to the relevant external code description and identifier. That process may be repeated for additional entries in the list or table. As described above, the list or table may represent fewer than all entries in the ontology and, more specifically, may represent the mappings being deactivated from the reference version to the customizable version. Thus, the user may not need to determine replacements for all entries in the list or table but instead may be able to limit review to those ontology descriptions that they anticipate continuing to use.

In one example, a previous release version may include an external code description mapped to the ontological description “fracture of arm or leg.” In that instance, the new version may turn off that mapping because it is ambiguous and because there may be two separate replacements, i.e., “fracture of arm” and “fracture of leg,” where one of those mappings accurately represents the problem being mapped to, as determined by a user's local usage of the content. Thus, if a user were to search for “arm fracture,” the system may return the ontological description “fracture of arm” and may update the mapping to the external code set with that description upon selection by the user.

In another instance, a user may want the system to recognize some of his or her shorthand abbreviations as being valid ontological abbreviations for the external code set description. For example, the user may want the system to recognize the term “ht” as “heart attack.” In this case, the search query may not recognize the connection between those terms, so that inputting “ht” into the search box may not return the desired result. As such, the system may open a directory of all ontological concepts within the domain being queried, e.g., a list of all problem-related concepts. Such a list may be sorted, e.g., alphabetically or into clusters or categories of related entries, thereby permitting the user to manually review the list for the desired match. Upon receiving a user selection of the desired concept, the system may facilitate the desired customization in at least one of two different ways.

First, the system may permit the user to add a local instance of a description mapped to the selected concept. This option may be better suited for situations where the desired description is viewed as a common alternative for one of the existing descriptions. For example, the system may permit the addition of a description “lung” for the concept “pulmonary” (presuming such a description was not already part of the interface terminology). Alternatively, the system may permit modification of the metadata associated with a description selected by the user after selecting the desired concept. In this second instance, the metadata associated with a concept or a description may include lesser-used synonyms, misspellings, or other variants of the description. For example, the user may wish to add the synonym “pmnry” to the local instance of the ontology mapping, as that may reflect a term used by the user but that may not be used commonly by other users. To do so, the system may generate a local synonym table that includes a column for the interface terminology concept or description (or an equivalent identifier), and a second column that includes the synonym entry. The local synonym table also may include a column to hold a status flag, e.g., that the synonym is active or retired.

The system also may facilitate the local modification of other types of metadata associated with the ontological mapping. For example, certain interface terminology or external code set concepts may include default flags reflecting variable such as age, gender, etc. In the vast majority of circumstances, those concepts may pertain to a specific group, such that the system may default a metadata flag to represent that group. At the same time, the end user may be faced with a situation presenting the exception to that default rule and may wish to create a local exception to the metadata flag. For example, the concept “cancer of ovary” may have a gender flag defaulted to “female,” as that is a concept almost entirely unique to females. However, as there are rare instances in which a male may have ovaries, the local user may encounter a situation of a male with the recorded problem “cancer of ovary.” In that case, the system may generate a local gender flag table, with a first entry for female and a second entry for male, with each entry having its own, unique flag, e.g., “1” for female and “2” for male. The system then may add a column to the local interface terminology concept table to make a gender query, whereby the user can set the flag to “2” for a given patient's record if applicable.

The system may facilitate the local modification of other forms of metadata, including permitting the user to set whether a certain interface terminology description is a clinician term or a person health term, i.e., whether it is the term commonly used by physicians at that facility or whether it reflects a more widely understood term to be provided to lay people. Additionally, with regard to the search feature described above and depicted in FIG. 9, the local user can customize the system to hide one or more terms from being displayed as a result of the search, e.g., by changing an “active status” metadata flag from “on” to “off”

As discussed above, the system may generate these local metadata variations by creating relevant local tables for each type of metadata being modified. Alternatively, the system may generate one or more general rule tables that may record each different type of change being made, with columns for the relevant changes and an additional column reflecting the metadata type. Thus, when the system generates the local instantiation, it can make the necessary local modifications by looking in one place for those changes.

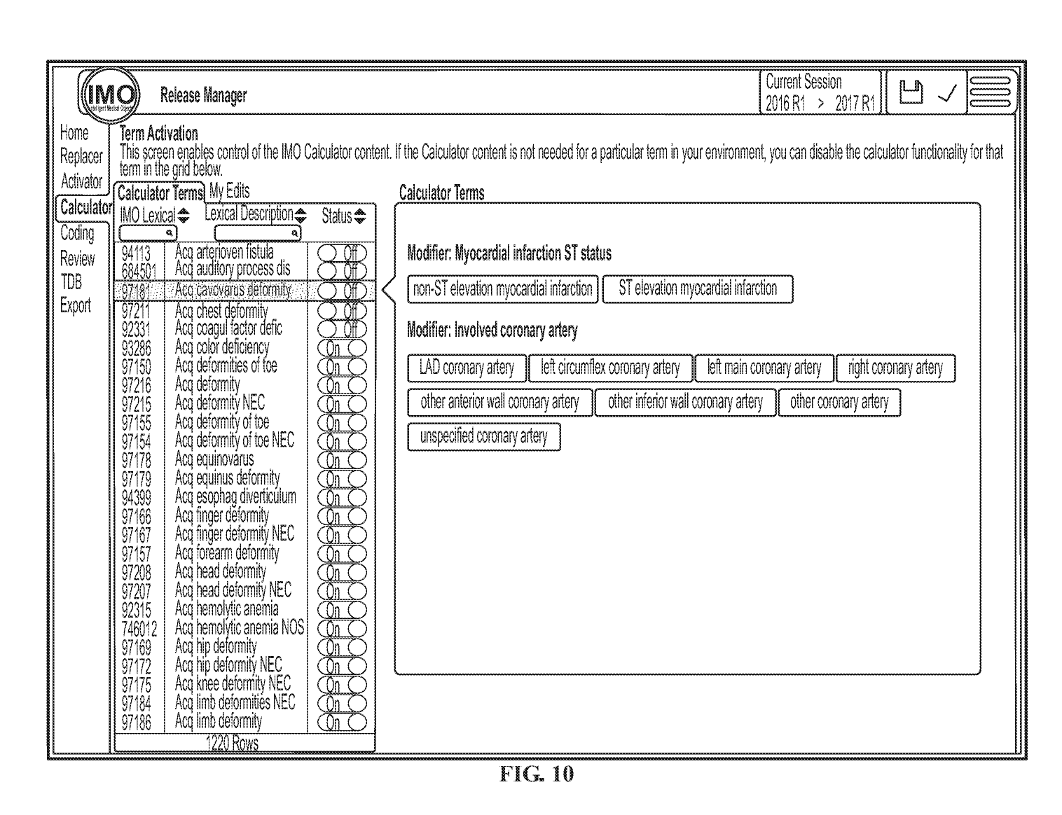

FIG. 10 depicts one example of a user interface for modifying certain types of metadata associated with the interface terminology. In that figure, the system provides the user with a plurality of radio buttons to turn the status of one or more interface terminology descriptions on or off. The system also presents the user, where applicable, with one or more modifiers potentially relatable to a selected description. Thus, the user quickly and easily can select the modifiers that are relevant to their local instantiation, further providing a customized solution.

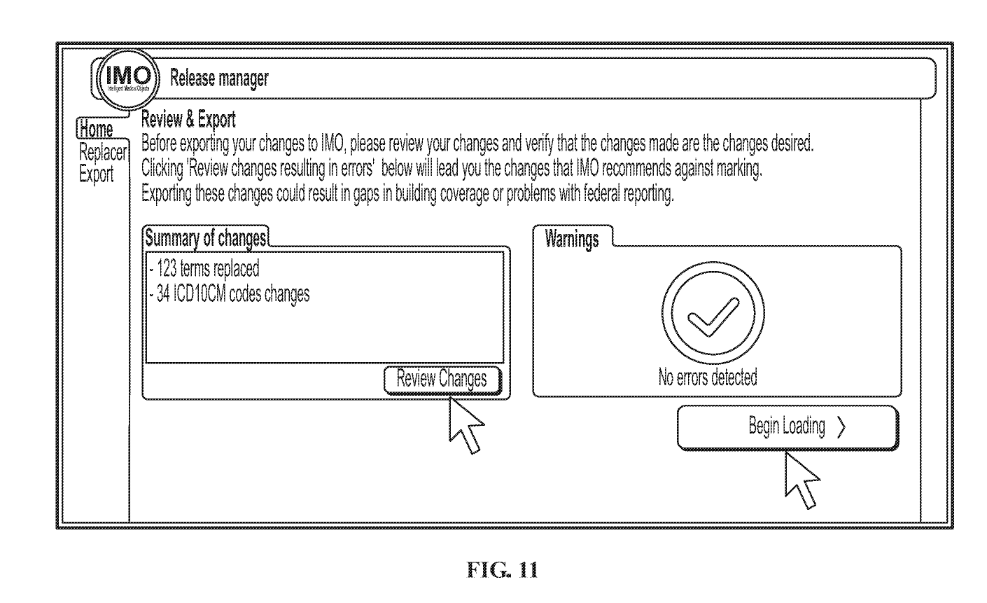

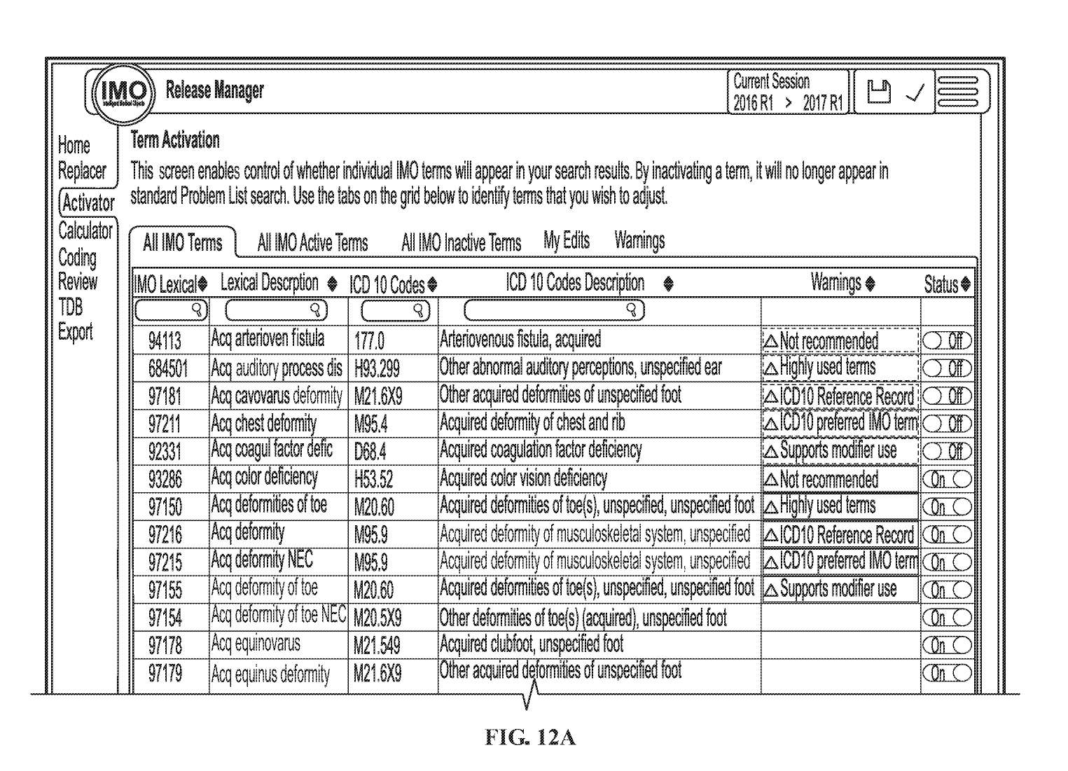

As seen in FIG. 11, once the user has reviewed the list or table to his or her satisfaction, the system may prompt the user to begin a build process, thereby permitting the user to create a customized local release version, i.e., a local instantiation of the ontology mapping.

The local release can take several forms. For example, it may involve rewriting the mapping data file, table, or database to replace existing maps with the user-defined maps, to remove system-defined maps, or to create new user-defined maps (e.g., when a user changes an ICD-10 mapping). One way to do this is to add or remove rows (or columns) in the table or database where each row (or column) includes one map.

Alternatively, the local release may be stored separately from the universal mapping data, e.g., by building out a distinct database object or table that holds each of the user-approved changes in a change/rule table, and then by universally or selectively applying the changes to the chosen target data file, which may be the file/database storing the customizable mapping selected earlier by the user. In that case, building the local release may involve loading the base or canonical data into a source database, loading the local revisions as another object, e.g., a rule table, in the database, and then updating the source database in accordance with the customized rules in the rule table. This process may involve, e.g., replacing a value in a column (or row) with an indicator that represents whether the mapping is active. For example, the column (or row) could contain a status indicator variable, where “0” corresponds to that mapping being inactive and “1” corresponds to that mapping being active. Thus, the mappings being deactivated may have their status indicator set to “0” and the mappings being user-added or modified may be set to “1.” Those mappings may be appended to the end of a mapping file, table, or database, or the system may be configured to read the universal mapping file first, then to read the local instantiation, replacing universal mapping entries with local entries where appropriate and/or adding local entries where no corresponding universal entry previously existed.

One advantage of mapping rules being stored in isolation from the databases or files containing the ontology and the one or more external codes and of the local instantiation maps may be stored separately from the records of universal maps, is permanence of the local instantiation. In other words, by separating the local maps from other ontology maps, those local maps may be applied to the customizable version each time a new such version is made available to the user, such that the system retains the user's preferences and eliminates the user's need to duplicate previous review work.

While the figures present the user with mappings between ontological descriptions and a single external code set, the process is extendable to make similar customizations to mappings between the ontological descriptions and other code sets. In one aspect, this may be accomplished by presenting each of the mapped code sets on the same list or table as the one shown in FIGS. 6A and 6B, e.g., as adjacent columns within the list or table. In another aspect, the system may include an option such as a drop-down or radio button to select the external code set being analyzed, whereupon the list or table is populated with the relevant external code set elements and descriptions based upon the user's selection.

In addition, the system may include audit trails so that changes can be walked back incrementally. Additionally, the system may permit batch rebuilds, where multiple rule changes are reversed, e.g., all changes made since the last version was released.

In addition to being stored locally, rules that third parties execute may be returned back to central computer system for analysis or consideration as to whether the third party change should be adopted system-wide. Thus, it is possible that a local ontology map may become a universal map in a later release version. In that case, in one instance, the system may delete the local map from the user's local map file upon its adoption as a universal map. In another instance, the system may retain the local map, in the event that the universal map is changed again at some future date.

While the system may permit local customization, it also may include features to prevent accidental or potentially detrimental user modifications to the ontology mapping. For example, the system may collect usage data corresponding to each mapping, using that data to determine which terms are used more often than others. The system then may cross-check proposed local mapping changes with those terms to prevent potentially inadvertent changes to frequently-used mappings, since changes may be made by a local system administrator or someone with less understanding of the impact making the change would have on the local system's users.

In addition to frequently used terms, the system also may prevent the user from modifying other classes of ontological mappings. For example, the system may include a preferred class of terms, where the preference comes, e.g., from the accuracy of the ontological description to the external code set entry. Additionally, the ontological mapping may include internal hierarchies, e.g., where one description maps to an external code that supports post-coordination, i.e., modifier use, and additional descriptions map to the external codes that apply the modifiers. In that case, the system may prevent the user from providing localized maps to the more general entry, since the impact of modifying that map may ripple down through the other, more specific entries.

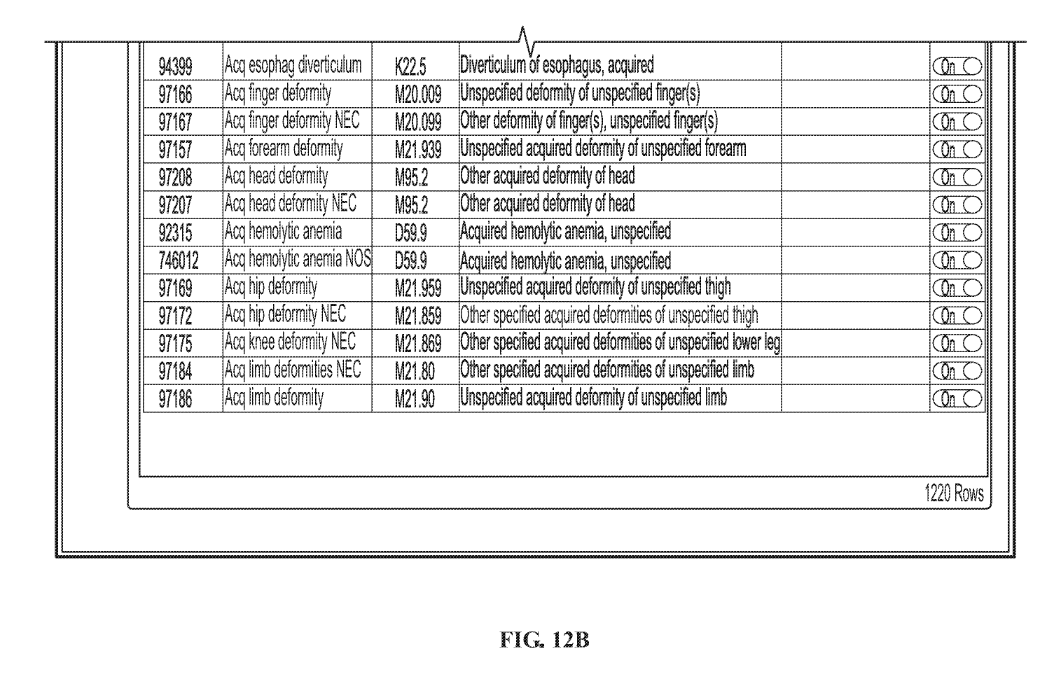

Alternatively, as seen in FIGS. 12A and 12B, rather than prohibiting a user from making the desired mapping change, the system may provide a visual and/or audible warning to the user or first require or suggest that the third-party operator inform its users of the proposed change, either to gauge their interest or agreement, or to help ensure that those users are informed of the proposed change in advance.

In one instance, the system and the relevant files or databases may be installed locally on a user's computer system. In another instance, the system may run on a virtual machine installed on the user's local computer. In yet another instance, the system may run on a central server dedicated to the user's organization. In still another instance, the system may be hosted in a cloud-computing environment that is accessible through, e.g., an Internet connection, by each third party organization seeking user customization.

Thus, the system and method as described herein allow for internal overrides or edits of mappings between elements of an ontology such as interface terminology descriptions and elements of one or more external code sets, such as ICD-10 or SNOMED CT. As such, users may be able to take advantage of a core ontological mapping to the external code sets and then extend that mapping to meet the needs specific to the users' organizations through customization of content and dynamic analytics based on the users' unique needs and usage data.

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

We claim:

1. A method for generating local deployments of ontological mappings, comprising:
receiving a user selection of a reference ontological mapping, wherein the reference ontological mapping is loaded on a computer system;
receiving a user selection of a customizable ontological mapping, wherein the customizable ontological mapping includes an indicator for one or more individual mappings within the customizable ontological mapping;
parsing the customizable ontological mapping according to the indicator for the one or more individual mappings;
generating a subset of the customizable ontological mapping based on the parsing step;
presenting the subset to a user;
receiving user-generated modifications to the subset; and
saving the user-generated modifications in a local instantiation of an ontological mapping.

2. The method of claim 1, further comprising:
loading the customizable ontological mapping;
loading the local instantiation; and
overwriting portions of the customizable ontological mapping with one or more portions of the local instantiation.

3. The method of claim 1, wherein the reference and customizable ontological mappings map elements of an interface terminology to elements of one or more external code sets.

4. The method of claim 3, wherein one of the one or more external code sets is a version of the International Classification of Diseases.

5. The method of claim 3, wherein one of the one or more external code sets is a version of the Systematized Nomenclature of Medicine.

6. The method of claim 1, wherein the subset comprises mappings that are deactivated.

7. The method of claim 1, wherein the subset comprises mappings that have been modified from an immediately prior release.

8. The method of claim 1, wherein the subset comprises mappings that are newly added.

9. The method of claim 1, further comprising:
prior to the saving step, confirming one or more of the user-generated modifications.

10. The method of claim 1, further comprising:
receiving a newer version of an ontological mapping; and
overwriting portions of the newer version with one or more portions of the local instantiation.

11. The method of claim 3, wherein the user-generated modifications include modifying a mapping between an element of the interface terminology and an element of the one or more external code sets.

12. The method of claim 3, wherein the interface terminology includes mappings among a concept and one or more descriptions, and wherein the user-generated modifications include modifying the mapping between the concept and at least one of the one or more descriptions.

13. The method of claim 12, wherein each description represents a semantic alternative way to express the concept to which the description is mapped.

14. The method of claim 3, wherein the step of receiving user-generated modifications includes receiving changes to metadata elements pertaining to the interface terminology.

15. A method for generating local deployments of ontological mappings, comprising:
receiving a user selection of a reference ontological mapping, wherein the reference ontological mapping is loaded on a computer system;
receiving a user selection of a customizable ontological mapping, wherein the customizable ontological mapping includes an indicator for one or more individual mappings within the customizable ontological mapping;
parsing the customizable ontological mapping according to the indicator for the one or more individual mappings;
generating a subset of the customizable ontological mapping based on the parsing step;
presenting the subset to a user;
receiving user-generated modifications to metadata affiliated with the subset; and
saving the user-generated modifications in a local instantiation of an ontological mapping.

16. The method of claim 15, further comprising:
generating one or more local database rule tables; and
recording the user-generated modifications to metadata in the local database rule tables.

17. The method of claim 15, further comprising:
loading the customizable ontological mapping;
loading the local instantiation; and
overwriting portions of the customizable ontological mapping with one or more portions of the local instantiation.

18. The method of claim 15, wherein the reference and customizable ontological mappings map elements of an interface terminology to elements of one or more external code sets.

19. The method of claim 18, wherein one of the one or more external code sets is a version of the International Classification of Diseases.

20. The method of claim 18, wherein one of the one or more external code sets is a version of the Systematized Nomenclature of Medicine.
